(19) United States
(12) Patent Application Publication
(10) Pub. No.: US 2020/0250776 A1
(43) Pub. Date: Aug. 6, 2020

(54) CROWDSOURCED AND SOCIAL MEDIA IP SEARCH AND ANALYTICS PLATFORM WITH STARTUP/INDUSTRY PARTNERSHIPS AND VIRTUAL INCUBATOR/ACCELERATOR INCLUDING AUTOMATED PATENT VALUATION SYSTEM

(71) Applicants: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(72) Inventors: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(21) Appl. No.: 16/758,392

(22) PCT Filed: Oct. 23, 2018
(86) PCT No.: PCT/US18/57062

§ 371 Date: Apr. 22, 2020

Related U.S. Application Data
(60) Provisional application No. 62/577,253, filed on Oct. 26, 2017.
(60) Provisional application No. 62/579,172, filed on Oct. 31, 2017.
(60) Provisional application No. 62/579,347, filed on Oct. 31, 2017.
(60) Provisional application No. 62/582,976, filed on Nov. 8, 2017.
(60) Provisional application No. 62/588,350, filed on Nov. 19, 2017.
(60) Provisional application No. 62/588,932, filed on Nov. 21, 2017.
(60) Provisional application No. 62/607,919, filed on Dec. 20, 2017.
(60) Provisional application No. 62/610,265, filed on Dec. 25, 2017.
(60) Provisional application No. 62/622,922, filed on Jan. 28, 2018.
(60) Provisional application No. 62/622,987, filed on Jan. 29, 2018.
(60) Provisional application No. 62/622,994, filed on Jan. 29, 2018.
(60) Provisional application No. 62/660,946, filed on Apr. 21, 2018.
(60) Provisional application No. 62/672,697, filed on May 17, 2018.
(60) Provisional application No. 62/685,299, filed on Jun. 15, 2018.
(60) Provisional application No. 62/685,937, filed on Jun. 16, 2018.
(60) Provisional application No. 62/685,960, filed on Jun. 16, 2018.
(60) Provisional application No. 62/689,241, filed on Jun. 24, 2018.
(60) Provisional application No. 62/695,002, filed on Jul. 7, 2018.
(60) Provisional application No. 62/695,126, filed on Jul. 8, 2018.
(60) Provisional application No. 62/696,357, filed on Jul. 11, 2018.
(60) Provisional application No. 62/575,610, filed on Oct. 23, 2017.
(60) Provisional application No. 62/576,516, filed on Oct. 24, 2017.

(51) Int. Cl. G06Q 50/18; G06Q 50/00

(52) U.S. Cl. CPC G06Q 50/18; G06Q 50/01

(57) ABSTRACT

The analytics embodiment uses artificial intelligence (AI), machine learning, predictive analytics and computerized analytics. The analytics embodiment generates patent analytics and intelligence to analyze and value patents. The analytics embodiment can have smartphone applications. Smartphone applications can provide notifications, alerts, reminders, etc. Smartphone applications can include key features, including navigation tools. The analytics embodiment can have a social media feature, so users can connect with each other (as in Facebook, LinkedIn, etc.) and/or follow other users (like in Twitter, LinkedIn and Medium). The analytics embodiment will facilitate crowdsource functionality for validity, relevance and valuation.

A corresponding IP platform could allow startups to partner with big companies, to get mentorship and industry partnerships. This can help the startups with connections and eventually get acquired. This is common at incubators/accelerators. Therefore, we can add a virtual incubator/accelerator. The virtual incubator can have experts teach the startups and advise them on raising angel and venture capital money. Angel investors and venture capitalists can be guest lecturers and provide advice to startups. Teachers can help startups prepare paperwork to apply for government grants, such as small business and STTR/SBIR tech transfer government grants.

Furthermore, a corresponding IP platform can have an automated patent valuation system. A user can enter 1. An individual patent or 2. A pool of multiple patents. Then, the IP platform will automatically calculate the patent valuation. The analytics embodiment is the IP platform search and analytics software system. Therefore, this automated patent valuation system can be part of the analytics embodiment. The automated valuation can show multiple different patent valuations, based on different valuation techniques. Also, the automated valuation can show all of the individual patent valuations. This automated valuation can include the mean, median, and/or average patent valuations from multiple different valuations, based on different valuation techniques.

### PRIORITY CLAIMS

This application claims the benefit of U.S. Provisional Patent Application No. 62/577,253, filed Oct. 26, 2017. This application also claims the benefit of U.S. Provisional Patent Application No. 62/579,172, filed Oct. 31, 2017. This application also claims the benefit of U.S. Provisional Patent Application No. 62/579,347, filed Oct. 31, 2017. This application also claims the benefit of International Patent Appl. No. PCT/US2018/56690, filed on Oct. 19, 2018, which claims the benefit of U.S. Provisional Patent Application No. 62/575,610, filed Oct. 23, 2017. This application also claims the benefit of International Patent Appl. No. PCT/US2018/56884, filed on Oct. 22, 2018, which claims the benefit of U.S. Provisional Patent Application No. 62/576,516, filed Oct. 24, 2017. This application also claims the benefit of U.S. Provisional Patent Application No. 62/582,976, filed Nov. 8, 2017. This application also claims the benefit of U.S. Provisional Patent Application No. 62/588,350, filed Nov. 19, 2017. This application also claims the benefit of U.S. Provisional Patent Application No. 62/588,932, filed Nov. 21, 2017. This application also claims the benefit of U.S. Provisional Patent Application No. 62/607,919, filed Dec. 20, 2017. This application also claims the benefit of U.S. Provisional Patent Application No. 62/610,265, filed Dec. 25, 2017. This application also claims the benefit of U.S. Provisional Patent Application No. 62/622,922, filed Jan. 28, 2018. This application also claims the benefit of U.S. Provisional Patent Application No. 62/622,987, filed Jan. 29, 2018. This application also claims the benefit of U.S. Provisional Patent Application No. 62/622,994, filed Jan. 29, 2018. This application also claims the benefit of U.S. Provisional Patent Application No. 62/660,946, filed Apr. 21, 2018. This application also claims the benefit of U.S. Provisional Patent Application No. 62/672,697, filed May 17, 2018. This application also claims the benefit of U.S. Provisional Patent Application No. 62/685,299, filed Jun. 15, 2018. This application also claims the benefit of U.S. Provisional Patent Application No. 62/685,937, filed Jun. 16, 2018. This application also claims the benefit of U.S. Provisional Patent Application No. 62/685,960, filed Jun. 16, 2018. This application also claims the benefit of U.S. Provisional Patent Application No. 62/689,241, filed Jun. 24, 2018. This application also claims the benefit of U.S. Provisional Patent Application No. 62/695,002, filed Jul. 7, 2018. This application also claims the benefit of U.S. Provisional Patent Application No. 62/695,126, filed Jul. 8, 2018. This application also claims the benefit of U.S. Provisional Patent Application No. 62/696,357, filed Jul. 11, 2018, each of which is incorporated herein by reference.

### FIELD OF THE INVENTION

Patents are a critically important asset class that promote innovation and encourage investment, economic growth and knowledge sharing. The introduction of blockchain and smart contracts will play a critical role in unlocking the value in the patent asset class. Currently, when a company requests a patent search to a specific patent search provider, the provider conducts its own patent search.

With respect to startups, for them to be very successful, it is beneficial to have worldwide sales. Furthermore, patent valuation deals with determining the price of a patent. Some important uses for patent valuation include: “In a sale, merger, joint venture or similar commercial transaction; In a divorce (be it personal or business related); Bankruptcy; Estate planning When licensing IP; and Litigation

### BACKGROUND OF THE INVENTION

One problem is that different patent search providers do not share their search strategies with each other. Different patent litigation cases involve the same patents. Different patent search providers conduct patent searches regarding the exact same patents. However, they do not share their search strategies and customized search queries (search terms and prior art references) with each other.

Another problem is that many global startups have trouble expanding worldwide. Many global startups do not have access to learning about venture capital and angel investing. Many global startups do not have the industry/company connections or mentors to teach them how to grow their business worldwide.

An additional problem is that there is no universal, central standard for valuing the price of a patent. There are at least 25 different methods of determining the price of a patent. The market and current events can possibly change and affect patent valuations.

### SUMMARY OF INVENTION

The analytics embodiment is a worldwide patent search and analytics software tool that provides patent metrics information, include a rating of the strength of a patent, a rating of the likely relevance and validity of the patent and valuation information. The analytics embodiment uses artificial intelligence (AI), machine learning, predictive analytics and computerized analytics. The analytics embodiment generates patent analytics and intelligence to analyze and value patents. The analytics embodiment can have smartphone applications. Smartphone applications can provide notifications, alerts, reminders, etc. Smartphone applications can include key features, including navigation tools. The analytics embodiment can have a social media feature, so users can connect with each other (as in Facebook, LinkedIn, etc.) and/or follow other users (like in Twitter, LinkedIn and Medium). The analytics embodiment will facilitate crowdsource functionality for validity, relevance and valuation.

The patent registry can use artificial intelligence (AI), machine learning, predictive analytics and computerized analytics. The patent registry can generate patent analytics and intelligence to analyze and value patents. The patent registry can have smartphone applications. Smartphone applications can provide notifications, alerts, reminders, etc. Smartphone applications can include key features, including navigation tools. The patent registry can have a social media feature, so users can connect with each other (as in Facebook, LinkedIn, etc.) and/or follow other users (like in Twitter, LinkedIn and Medium). The patent registry can facilitate crowdsource functionality for validity, relevance and valuation.

The patent registry and/or the analytics embodiment can be self-regulated platforms. These two platforms can be subject to terms of use. As such, users are subject to rules. For example, patent holders or blessed verifiers who declare fake statements repetitively could be penalized. The penalty could be a loss of a certain amount of tokens. The penalty could be being banned from using the patent registry and/or the analytics embodiment. Any other penalty could be allowed.

The IP platform and/or the analytics embodiment can have a feature, where people can share and retrieve/access/use other people's patent search queries/patent searches. For example, there can be a database of saved patent searches. When someone needs to conduct a patent search or prepare a patent opinion, he can access related patent searches for the target subject patent. He will be able to view the customized search queries of the previous saved patent searches, such as (“hybrid and car and electric”). That will assist him in conducting his patent search. Also, there will be a crowdsourced function, so that anyone from the public can comment. That will assist people in finding prior art. For example, one person in country A can give advice on finding element A, and then a second person in country B can give advice on finding element B. This crowdsourced function will have a social media aspect, wherein all of the patent searchers can interact with each other. They can give constructive criticism and share opinions to help assist each other with their patent searches.

For example, if a patent searcher cannot find a specific element, he could request that someone conduct a search for Korean or Japanese patent and/or non-patent literature (NPL) for a specific element. This crowdsourced and social media aspect can also be used for preparing patent reports, such as patent valuation reports. This crowdsourced and social media aspect can also be used by expert witnesses, such as to value patent litigation economic damages. This crowdsourced and social media aspect can also be used by anyone for any area of law. This crowdsourced and social media aspect can also be used for any non-legal purposes.

Regarding the number/code in the blockchain (the patent registry), the logo of the company performing the operation will be downloaded, and the logo will be displayed next to it. It will be nice to have a sort of visual identity for identifying users. Perhaps, we could also make available avatar images to inventors, individual brokers and individual investors, since they may not have a corporate logo (to easily spot who is who in the game).

The IP platform and/or the analytics embodiment platform can have crowdsourcing functionality. Here are the different types of crowdsourcing functionality:

1. Funding—a way to participate in the asset class by investing in patent applications they like, such as $100 or $1,000.
2. Funding (or financing)—a way to participate in commercialization, licensing, litigation by investing money ($X)
3. Invalidity—patent owners are not going to like this one

### 4. Infringement

### 5. Freedom to Operate

### 6. Competitive Monitoring/Competitive Analysis

### 7. Landscaping/Mapping

8. Any legal services
9. Any non-legal services

Accordingly, by way of a publicly available portal, people can submit ideas for improvements, suggestions and feedback.

An IP platform according to the present invention could allow startups to partner with big companies, to get mentorship and industry partnerships. This can help the startups with connections and eventually get acquired. This is common at incubators/accelerators. Therefore, we can add a virtual incubator/accelerator. The virtual incubator can have experts teach the startups and advise them on raising angel and venture capital money. Angel investors and venture capitalists can be guest lecturers and provide advice to startups. Teachers can help startups prepare paperwork to apply for government grants, such as small business and STTR/SBIR tech transfer government grants.

This is for alliances/partnerships. This is for networking and strategic alliances/mentorships. Anyone could sign up to be a mentor. A startup might have to pay THE IP PLATFORM coins to get this mentor service. A mentor or company might receive The IP platform coins for providing mentoring services. Alternatively, mentors and industry partners might have to be pre-approved by The IP platform by a human review committee, or by automatic software, to ensure the quality of the mentors. Mentors might have to have specific minimum requirements or a track record of success.

Like incubators and accelerators, The IP platform could get a small fractional share ownership of the startups in virtual accelerator/incubator, such as 5%. Industry partners and mentors could also receive a small fractional share ownership of the startups in virtual accelerator/incubator, such as 5%. Mentors could receive The IP platform Coins for being a mentor.

Also, there is the separate The IP platform Deal Room, dealing specifically with transactions (buying, selling, and licensing of IP).

The industry/startup partnerships, virtual accelerator/incubator, The IP platform Deal Room, and IP Platform all can have smartphone applications. Smartphone applications can provide notifications, alerts, reminders, etc. Smartphone applications can include key features, including navigation tools.

The industry/startup partnerships, virtual accelerator/incubator, The IP platform Deal Room, and IP Platform can have a social media feature, so users can connect with each other (as in Facebook, LinkedIn, etc.) and/or follow other users (like in Twitter, LinkedIn and Medium).

The industry/startup partnerships, virtual accelerator/incubator, and IP Platform can facilitate crowdsource functionality to pick and select which startups should be allowed access to mentors. The public could vote to select startups to be granted permission to gain access to mentors. The IP platform could have a selection committee to decide which startups are allowed access to the virtual incubator/accelerator. The public could vote on which people or companies should be selected as mentors.

Startups could be partnered with companies, even without the startup having to go through the virtual accelerator/incubator.

Artificial intelligence (AI), machine learning, predictive analytics and computerized analytics could be utilized to select startups and companies to be granted access to the industry/startup partnership program. Artificial intelligence (AI), machine learning, predictive analytics and computerized analytics could be utilized to pair and match startups with companies in the industry/startup partnership program.

The industry/startup partnerships, virtual accelerator/incubator, and IP Platform can be self-regulated platforms. These platforms can be subject to terms of use. As such, users are subject to rules. For example, patent holders or blessed verifiers who declare fake statements repetitively could be penalized. The penalty could be a loss of a certain amount of tokens. The penalty could be being banned from using the IP Platform, The patent registry and/or the analytics embodiment. Startups could vote on the quality of the mentors, during and after the startups being partnered with mentors. Mentors could vote on the quality of the startups, during and after being partnered with startups. This feedback could be used to give incentives for good behavior. Penalties for bad quality behavior, such as bad mentorship could include the mentor being banned from being a mentor in the future. The mentor could be banned from the IP platform. Any other penalty could be allowed.

The industry/startup alliance partnership program, virtual accelerator/incubator could have a login ID and password. It could give access to startups (either only during the program or forever in the future, including after the program ends) for the startup to access a complete file library or repository of saved documents, including sample business plans, sample pitch decks, advice on seeking venture capital/angel investment, best practices in sales, marketing, coding/computer programming best practices, or any other information that could possibly be helpful to the startup, etc.

Other service providers in the virtual incubator/accelerator could include any service provider, such as public relations experts, social media experts, marketing experts, etc. Any service provider could offer their services to the startups.

An IP platform according to the present invention can have an automated patent valuation system. A user can enter 1. An individual patent or 2. A pool of multiple patents. Then, The IP platform will automatically calculate the patent valuation. The analytics embodiment is the IP platform search and analytics software system. Therefore, this automated patent valuation system can be part of the analytics embodiment. This valuation can also be used for any type of IP (trademarks, copyrights, trade secrets, etc.). This valuation can also be used for any tangible asset, any intangible asset, any product, any service, any legal product/service, any non-legal product/service, etc.

The automated valuation can show multiple different patent valuations, based on different valuation techniques. Also, the automated valuation can show all of the individual patent valuations. This automated valuation can include the mean, median, and/or average patent valuations from multiple different valuations, based on different valuation techniques. Any other information could also be included in this patent valuation.

The IP platform can allow a user to select from an unlimited number of different valuation techniques/methods. The IP platform could be set to only allow one pre-set IP platform valuation technique/method.

The IP platform valuation could be 100% automated, and automatically conduct the patent valuation. Alternatively, the IP platform could allow a crowdfunded aspect. In the crowdfunded aspect, an unlimited number of people (such as Certified Valuation Analysts (CFAs) could conduct patent valuations. A user could request that a certain patent valuation technique be used. Each patent valuation analyst could show the patent valuation method that they used. Any patent valuation analyst could tag a patent, to show that additional information exists for that patent (including the uploaded The IP platform patent valuation report and analysis he prepared).

This non-automated valuation can include the mean, median, and/or average patent valuations from multiple different patent brokers. Also, the non-automated valuation can show all of the individual patent valuations.

The public could vote on the quality of the patent valuation analyst's analysis. The patent valuation analyst could have his contact information available, so that people could contact him for further questions. There could be a Chat Room so that people can interact directly with the patent valuation analyst. The date of each patent valuation can be included, since more recent valuations might be more reliable and accurate.

The IP platform could ban and prevent certain people from valuing patents, such as if the quality of their work product is not good. Therefore, there can be a social media or crowdfunding aspect, wherein everyone can rate the quality of the patent valuation analyst's work product.

The IP platform could require that patent valuation analysts pass some kind of patent valuation certification, or undergo some kind of patent valuation training. This would help ensure that the patent valuation analysts have some minimum amount patent valuation knowledge.

The IP platform could lobby to pass regulations to form individual domestic (country) patent valuation standards. The IP platform could invent its own patent valuation standards (and best practices). The IP platform could have one set patent valuation technique/method. Harmonizing an unlimited number of patent valuation techniques would provide more certainty to the field. The IP platform could lobby to try to create one worldwide patent valuation standard. The IP platform could develop a worldwide patent valuation technique/method or worldwide patent valuation standard.

Blockchain technology could be used with all, some, or none of this invention.

### BRIEF DESCRIPTION OF THE DRAWINGS

FIG. 1 is a diagram of how payment annuities are facilitated using the present invention.

FIG. 2 is a diagram of patent licensing using the present invention.

FIG. 3 is a diagram of patent sale and assignment transactions using the present invention.

FIG. 4 is a diagram of tokenized patent-based lending using the present invention.

FIG. 5 is a diagram of tokenized patent monetization using the present invention.

FIG. 6 is a diagram of patent defense aggregation using the present invention.

FIG. 7 is a diagram of the patent pooling process using the present invention.

FIG. 8 is a diagram of the patent title confirmation process using the present invention.

### DETAILED DESCRIPTION OF THE PREFERRED EMBODIMENT

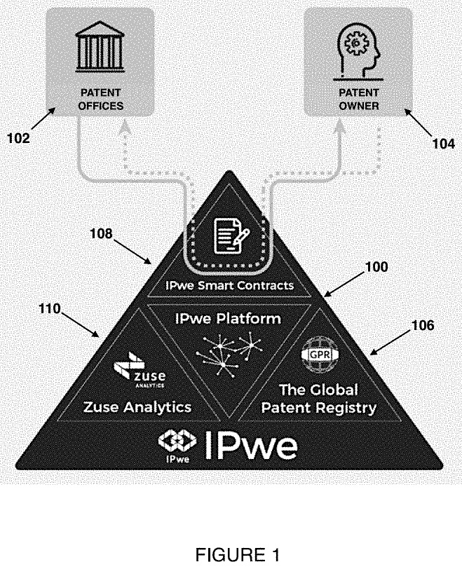

FIG. 1 is a diagram of how payment annuities are facilitated using the present invention. In accordance with the preferred embodiment of the present invention 100, once the patent office 102 has granted a patent to a patent owner 104, the global patent registry 106 is updated and the patent owner 104 pays the annuity fee to the patent office 102. The smart contracts embodiment 108 of the present invention 100 is then used for identification of patents and patent owners as well as the payment of annuities. The present invention 100 updates the global patent registry 106 and subsequently handles all analytics 110, annuity payments and patent contracts on behalf of the patent owner.

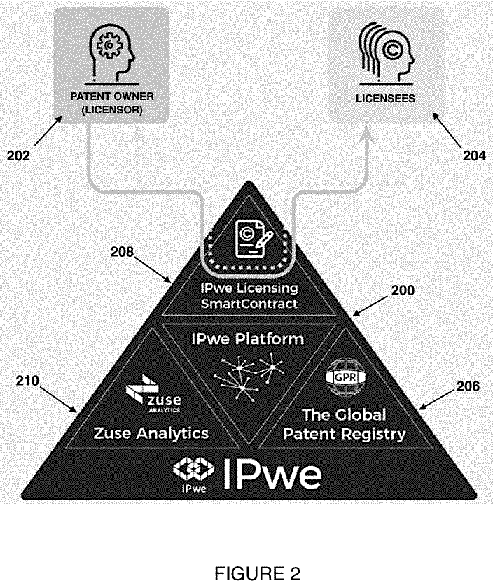

FIG. 2 is a diagram of patent licensing using the present invention. In accordance with the preferred embodiment of the present invention 200, the patent owner 202 licenses certain Licensees 204 under the selected patents. The Patent owner collects payments and royalties from the Licensees, and the licensing smart contracts embodiment 208 of the present invention is used to facilitate the identification of the patents, execution and payment of the license agreement, the terms of the license agreement, and whether any terms are made public. The present invention 200 provides an analysis 210, licensing agreements, title verification, reporting to the patent registry 206, annuity payments, royalty administration and transactional support to the patent owner 202.

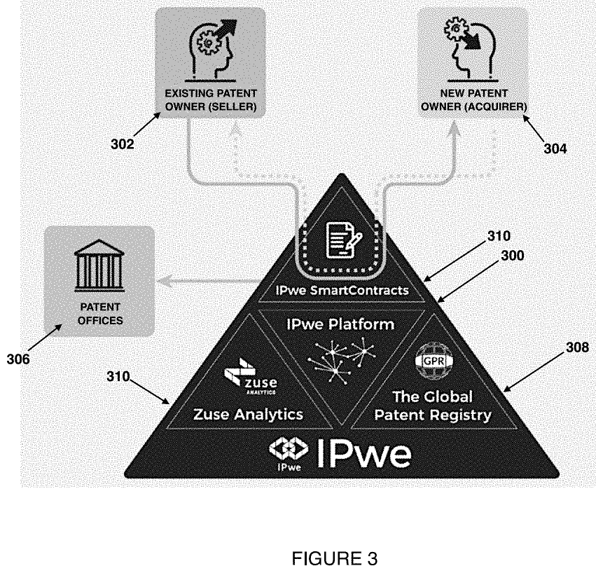

FIG. 3 is a diagram of patent sale and assignment transactions using the present invention. In accordance with the preferred embodiment of the present invention 300, the patent seller 302 sells patents to a patent acquirer 304 and receives funds from the patent sale. The patent office 306 then receives the assignment information and the global patent registry 308 is updated. The smart contracts 310 embodiment of the present invention 300 governs the identification of the patents and title updates, automatic execution of the sale including payments and reversions on default, the terms of agreement of sale, and whether the terms are made public. The present invention 300 then provides updates to the global patent registry 308, analysis of the sale, annuity payments, title verification, sale agreements and transactional support to the patent owner/seller 302.

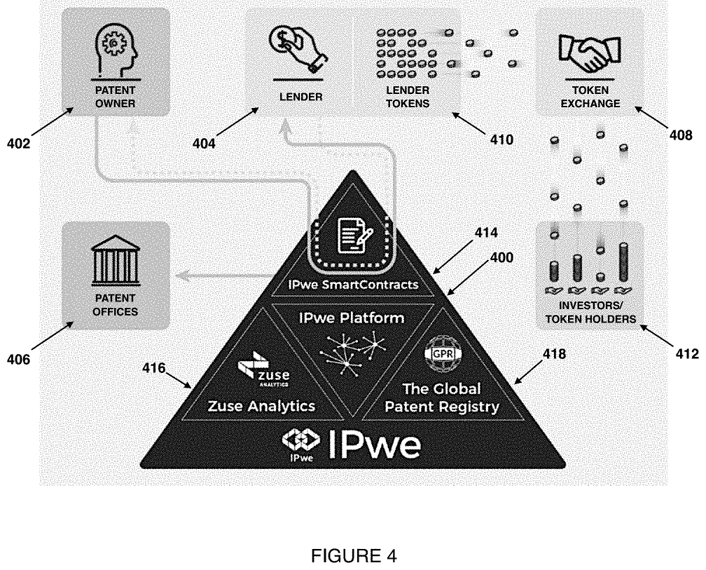

FIG. 4 is a diagram of tokenized patent-based lending using the present invention. In accordance with the preferred embodiment of the present invention 400, the patent owner 402 pledges patents to lenders 404. The lenders then provide financing and the patent owner repays the loan. The patent offices 406 are informed about the pledge and release and the token exchange 408 organizes the liquidity of the lender tokens 410 among investors 412. The smart contracts embodiment 414 of the present invention 400 governs the automatic execution and payment of the pledge, identification of all patents and parties involved in the transaction, the terms of the loan and the token holder's rights. The present invention 400 provides analytics of the transaction 416, pledge agreements, reporting to the global patent registry 418, annuity payments, title verification, research and transactional support to the patent owner 402 and the lender 404.

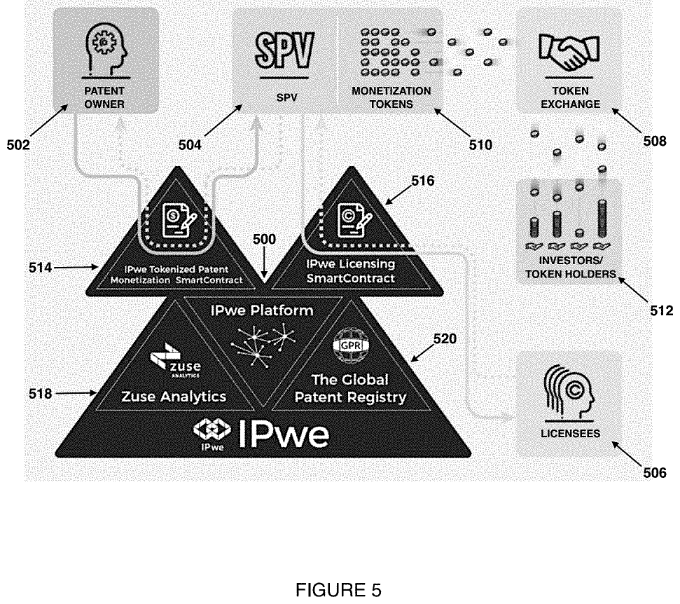

FIG. 5 is a diagram of tokenized patent monetization using the present invention. In accordance with the preferred embodiment of the present invention 500, the patent owner transfers 502 the ownership of selected patents to a Special Purpose Vehicle (“SPV”) 504, and receives funds. The SPV 504 sets rules of the licensing program to licensees 506 and collects royalty payments. The token exchange 508 organizes the liquidity of the monetization tokens 510 among the investors/token holders 512. The tokenization smart contract embodiment 514 of the present invention 500 governs the automatic execution and payment of the transaction, the identification of the patents and parties involved in the transaction and the investor/token holder's 512 rights. The licensing smart contract embodiment 516 of the present invention governs the automatic execution and payment of the transaction, the identification of the patents and parties involved in the transaction, the terms of the license and whether any terms are made public. The present invention 500 provides analytics 518 and transaction agreements, reporting of the transaction to the global patent registry 520, annuity payments, title verification and royalty administration to the involved parties.

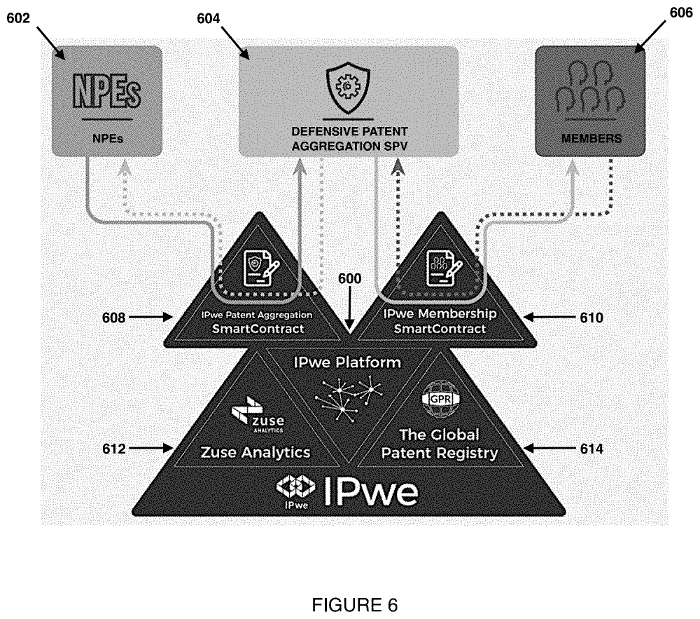

FIG. 6 is a diagram of patent defense aggregation using the present invention. In accordance with the preferred embodiment of the present invention 600, Non-Practicing Entities (“NPEs”) 602 sell patents or licensing rights to Defensive Patent Aggregation SPV 604, which then grants licenses to members 606 and collects membership fees and payments. The patent aggregation smart contracts embodiment 608 governs automatic execution and payments, identification of patents and parties, and the terms of the patent sale or licensing rights. The membership smart contracts embodiment 610 governs membership automatic execution and payments, member rights in the SPV, and the terms of membership. The present invention 600 provides analytics 612, reporting to the global patent registry 614, royalty administration and transactional support.

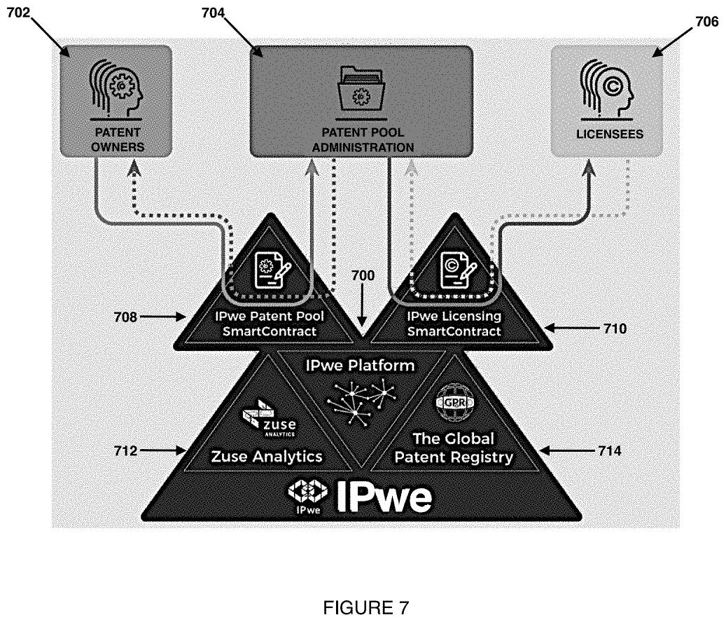

FIG. 7 is a diagram of the patent pooling process using the present invention. In accordance with the preferred embodiment of the present invention 700, patent owners 702 give licensing rights to the patent pool administration 704 and set the terms. The patent pool administration 704 grants licenses to licensees 706, collects royalties and redistributes those royalties to patent owners 702. The patent pool smart contracts embodiment 708 governs the identification of patents and parties, the terms of the license, and revenue share among patent owners. The licensing smart contracts embodiment 710 governs automatic execution and payments, identification of patents and parties, the terms of the license and whether terms are to be made public. The present invention 700 provides analytics 712, future tokenization opportunities, reporting to the global patent registry 714, royalty administration and transactional support.

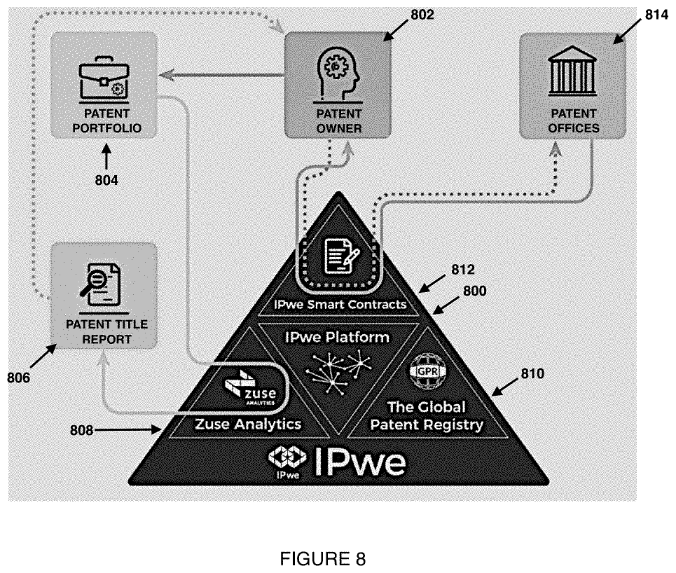

FIG. 8 is a diagram of the patent title confirmation process using the present invention. In accordance with the preferred embodiment of the present invention 800, the patent owner 802 identifies patents included in the patent owner's portfolio 804 (entire portfolio or segment transacting), and electronically submits to the analytics embodiment 808 and selects the patent ownership report 806. The analytics embodiment 808 compares ownership records at various patent offices and the global patent registry 810, and using AI analytics, issues a patent title report 806 indicating any patent ownership title discrepancies identified. The patent owner 802 then electronically selects any patent records it wishes to correct. The smart contracts embodiment 812 identifies the required patent office forms and procedures to correct any title defects. The required forms are provided to the patent owner 802 for completion, review, execution and filing with the appropriate patent office 814. The present invention 800 then updates the global patent registry 810.

The analytics embodiment is a worldwide patent search and analytics software tool that provides patent metrics information, include a rating of the strength of a patent, a rating of the likely relevance and validity of the patent and valuation information. The analytics embodiment uses artificial intelligence (AI), machine learning, predictive analytics and computerized analytics. The analytics embodiment generates patent analytics and intelligence to analyze and value patents. The analytics embodiment can have smartphone applications. Smartphone applications can provide notifications, alerts, reminders, etc. Smartphone applications can include key features, including navigation tools. The analytics embodiment can have a social media feature, so users can connect with each other (as in Facebook, LinkedIn, etc.) and/or follow other users (like in Twitter, LinkedIn and Medium). The analytics embodiment will facilitate crowdsource functionality for validity, relevance and valuation.

The patent registry can use artificial intelligence (AI), machine learning, predictive analytics and computerized analytics. The patent registry can generate patent analytics and intelligence to analyze and value patents. The patent registry can have smartphone applications. Smartphone applications can provide notifications, alerts, reminders, etc. Smartphone applications can include key features, including navigation tools. The patent registry can have a social media feature, so users can connect with each other (as in Facebook, LinkedIn, etc.) and/or follow other users (like in Twitter, LinkedIn and Medium). The patent registry can facilitate crowdsource functionality for validity, relevance and valuation.

The patent registry and/or analytics embodiment can be self-regulated platforms. These two platforms can be subject to terms of use. As such, users are subject to rules. For example, patent holders or blessed verifiers who declare fake statements repetitively could be penalized. The penalty could be a loss of a certain amount of tokens. The penalty could be being banned from using the patent registry and/or analytics embodiment. Any other penalty could be allowed.

The IP platform and/or analytics embodiment can have a feature, where people can share and retrieve/access/use other people's patent search queries/patent searches. For example, there can be a database of saved patent searches. When someone needs to conduct a patent search or prepare a patent opinion, he can access related patent searches for the target subject patent. He will be able to view the customized search queries of the previous saved patent searches, such as (“hybrid and car and electric”). That will assist him in conducting his patent search. Also, there will be a crowdsourced function, so that anyone from the public can comment. That will assist people in finding prior art. For example, one person in country A can give advice on finding element A, and then a second person in country B can give advice on finding element B. This crowdsourced function will have a social media aspect, wherein all of the patent searchers can interact with each other. They can give constructive criticism and share opinions to help assist each other with their patent searches.

For example, if a patent searcher cannot find a specific element, he could request that someone conduct a search for Korean or Japanese patent and/or non-patent literature (NPL) for a specific element. This crowdsourced and social media aspect can also be used for preparing patent reports, such as patent valuation reports. This crowdsourced and social media aspect can also be used by expert witnesses, such as to value patent litigation economic damages. This crowdsourced and social media aspect can also be used by anyone for any area of law. This crowdsourced and social media aspect can also be used for any non-legal purposes.

Regarding the number/code in the blockchain (the patent registry), the logo of the company performing the operation will be downloaded, and the logo will be displayed next to it. It will be nice to have a sort of visual identity for identifying users. Perhaps, we could also make available avatar images to inventors, individual brokers and individual investors, since they may not have a corporate logo (to easily spot who is who in the game).

The IP platform and/or analytics embodiment platform can have crowdsourcing functionality. Here are the different types of crowdsourcing functionality.

1. Funding—a way to participate in the asset class by investing in patent applications they like, such as $100 or $1,000.
2. Funding (or financing)—a way to participate in commercialization, licensing, litigation by investing money ($X)
3. Invalidity—patent owners are not going to like this one

### 4. Infringement

### 5. Freedom to Operate

### 6. Competitive Monitoring/Competitive Analysis

### 7. Landscaping/Mapping

8. Any legal services
9. Any non-legal services

On our website, people can submit ideas for improvements, suggestions, feedback.

The IP platform could allow startups to partner with big companies, to get mentorship and industry partnerships. This can help the startups with connections and eventually get acquired. This is common at incubators/accelerators. Therefore, we can add a virtual incubator/accelerator. The virtual incubator can have experts teach the startups and advise them on raising angel and venture capital money. Angel investors and venture capitalists can be guest lecturers and provide advice to startups. Teachers can help startups prepare paperwork to apply for government grants, such as small business and STTR/SBIR tech transfer government grants.

This is for alliances/partnerships. This is for networking and strategic alliances/mentorships. Anyone could sign up to be a mentor. A startup might have to pay THE IP PLATFORM coins to get this mentor service. A mentor or company might receive The IP platform coins for providing mentoring services. Alternatively, mentors and industry partners might have to be pre-approved by The IP platform by a human review committee, or by automatic software, to ensure the quality of the mentors. Mentors might have to have specific minimum requirements or a track record of success.

Like incubators and accelerators, The IP platform could get a small fractional share ownership of the startups in virtual accelerator/incubator, such as 5%. Industry partners and mentors could also receive a small fractional share ownership of the startups in virtual accelerator/incubator, such as 5%. Mentors could receive The IP platform Coins for being a mentor. Also, there is the separate The IP platform Deal Room, dealing specifically with transactions (buying, selling, and licensing of IP).

The industry/startup partnerships, virtual accelerator/incubator, The IP platform Deal Room, and IP Platform all can have smartphone applications. Smartphone applications can provide notifications, alerts, reminders, etc. Smartphone applications can include key features, including navigation tools.

The industry/startup partnerships, virtual accelerator/incubator, The IP platform Deal Room, and IP Platform can have a social media feature, so users can connect with each other (as in Facebook, LinkedIn, etc.) and/or follow other users (like in Twitter, LinkedIn and Medium).

The industry/startup partnerships, virtual accelerator/incubator, and IP Platform can facilitate crowdsource functionality to pick and select which startups should be allowed access to mentors. The public could vote to select startups to be granted permission to gain access to mentors. The IP platform could have a selection committee to decide which startups are allowed access to the virtual incubator/accelerator. The public could vote on which people or companies should be selected as mentors. Startups could be partnered with companies, even without the startup having to go through the virtual accelerator/incubator.

Artificial intelligence (AI), machine learning, predictive analytics and computerized analytics could be utilized to select startups and companies to be granted access to the industry/startup partnership program. Artificial intelligence (AI), machine learning, predictive analytics and computerized analytics could be utilized to pair and match startups with companies in the industry/startup partnership program.

The industry/startup partnerships, virtual accelerator/incubator, and IP Platform can be self-regulated platforms. These platforms can be subject to terms of use. As such, users are subject to rules. For example, patent holders or blessed verifiers who declare fake statements repetitively could be penalized. The penalty could be a loss of a certain amount of tokens. The penalty could be being banned from using the IP Platform, The patent registry and/or analytics embodiment. Startups could vote on the quality of the mentors, during and after the startups being partnered with mentors. Mentors could vote on the quality of the startups, during and after being partnered with startups. This feedback could be used to give incentives for good behavior. Penalties for bad quality behavior, such as bad mentorship could include the mentor being banned from being a mentor in the future. The mentor could be banned from the IP platform. Any other penalty could be allowed.

The industry/startup alliance partnership program, virtual accelerator/incubator could have a login ID and password. It could give access to startups (either only during the program or forever in the future, including after the program ends) for the startup to access a complete file library or repository of saved documents, including sample business plans, sample pitch decks, advice on seeking venture capital/angel investment, best practices in sales, marketing, coding/computer programming best practices, or any other information that could possibly be helpful to the startup, etc.

Other service providers in the virtual incubator/accelerator could include any service provider, such as public relations experts, social media experts, marketing experts, etc. Any service provider could offer their services to the startups.

The IP platform can have an automated patent valuation system. A user can enter 1. An individual patent or 2. A pool of multiple patents. Then, The IP platform will automatically calculate the patent valuation. The analytics embodiment is the IP platform search and analytics software system. Therefore, this automated patent valuation system can be part of the analytics embodiment. This valuation can also be used for any type of IP (trademarks, copyrights, trade secrets, etc.). This valuation can also be used for any tangible asset, any intangible asset, any product, any service, any legal product/service, any non-legal product/service, etc.

The automated valuation can show multiple different patent valuations, based on different valuation techniques. Also, the automated valuation can show all of the individual patent valuations. This automated valuation can include the mean, median, and/or average patent valuations from multiple different valuations, based on different valuation techniques. Any other information could also be included in this patent valuation.

The IP platform can allow a user to select from an unlimited number of different valuation techniques/methods. The IP platform could be set to only allow one pre-set IP platform valuation technique/method.

The IP platform valuation could be 100% automated, and automatically conduct the patent valuation. Alternatively, The IP platform could allow a crowdfunded aspect. In the crowdfunded aspect, an unlimited number of people (such as Certified Valuation Analysts (CFAs) could conduct patent valuations. A user could request that a certain patent valuation technique be used. Each patent valuation analyst could show the patent valuation method that they used. Any patent valuation analyst could tag a patent, to show that additional information exists for that patent (including the uploaded The IP platform patent valuation report and analysis he prepared).

This non-automated valuation can include the mean, median, and/or average patent valuations from multiple different patent brokers. Also, the non-automated valuation can show all of the individual patent valuations.

The public could vote on the quality of the patent valuation analyst's analysis. The patent valuation analyst could have his contact information available, so that people could contact him for further questions. There could be a Chat Room so that people can interact directly with the patent valuation analyst. The date of each patent valuation can be included, since more recent valuations might be more reliable and accurate.

The IP platform could ban and prevent certain people from valuing patents, such as if the quality of their work product is not good. Therefore, there can be a social media or crowdfunding aspect, wherein everyone can rate the quality of the patent valuation analyst's work product.

The IP platform could require that patent valuation analysts pass some kind of patent valuation certification, or undergo some kind of patent valuation training. This would help ensure that the patent valuation analysts have some minimum amount patent valuation knowledge.

The IP platform could lobby to pass regulations to form individual domestic (country) patent valuation standards. The IP platform could invent its own patent valuation standards (and best practices). The IP platform could have one set patent valuation technique/method. Harmonizing an unlimited number of patent valuation techniques would provide more certainty to the field. The IP platform could lobby to try to create one worldwide patent valuation standard. The IP platform could develop a worldwide patent valuation technique/method or worldwide patent valuation standard.

Blockchain technology could be used with all, some, or none of this invention.

Persons of ordinary skill in the art will realize that the foregoing description is illustrative only and not in any way limiting. Other modifications and improvements will readily suggest themselves to such skilled persons having the benefit of this disclosure.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

1. A platform comprising: a system of using crowdsourcing to assist with legal services.

2. (canceled)

3. A platform comprising: a system of using blockchain to assist with a virtual incubator or virtual accelerator.

4. A platform comprising: a system of using crowdsourcing to assist with industry/startup partnerships.

5. A platform comprising: a system of using crowdsourcing to assist with a virtual incubator or virtual accelerator.

6. A platform comprising: a system of using blockchain to assist with patent valuation.

7. A platform comprising: a system of using crowdsourcing to assist with patent valuation.
